(19) United States
(12) Patent Application Publication
(10) Pub. No.: US 2024/0281940 A1
(43) Pub. Date: Aug. 22, 2024

(54) COMPUTATIONAL IMAGE CONTRAST FROM MULTI-DIMENSIONAL DATA

(71) Applicant: Duke University, Durham, NC (US)

(72) Inventors: Kevin Zhou, Durham, NC (US); Ryan McNabb, Durham, NC (US); Ruobing Qian, Durham, NC (US); Al-Hafeez Dhalla, Durham, NC (US); Sina Farsiu, Durham, NC (US); Joseph Izatt, Durham, NC (US)

(21) Appl. No.: 18/581,157

(22) Filed: Feb. 19, 2024

Related U.S. Application Data
(60) Provisional application No. 63/446,378, filed on Feb. 17, 2023.

(51) Int. Cl. G06T 5/90; G06T 3/4053; G06T 7/30

(52) U.S. Cl. CPC G06T 5/90; G06T 3/4053; G06T 7/30; G06T 2207/10101; G06T 2207/20084

(57) ABSTRACT

A method of performing computational image contrast from multidimensional data includes receiving a plurality of images of an object, with each image of the plurality of images having more than three dimensions, performing multi-dimensional registration of the plurality of images to generate a multi-dimensional dataspace, reducing dimensionality of the multi-dimensional dataspace to create an enhanced resolution and contrast image of a 3D space of the object using the plurality of images as registered in the multi-dimensional dataspace, and displaying the enhanced resolution and contrast image. In some cases, reducing the dimensionality of the multi-dimensional dataspace to create the enhanced resolution and contrast image of the 3D space of the object comprises utilizing at least one of variance, high-order statistics, entropy, principal component analysis, t-distributed stochastic neighborhood embedding, and neural networks using the plurality of images as registered in the multi-dimensional dataspace.

### CROSS-REFERENCE TO RELATED APPLICATIONS

This application claims the benefit of U.S. Provisional Application Ser. No. 63/446,378, filed Feb. 17, 2023.

### STATEMENT REGARDING FEDERALLY SPONSORED RESEARCH

This invention was made with Government support under Federal Grant no. CBET-1902904 awarded by the National Science Foundation. The Federal Government has certain rights to this invention.

### BACKGROUND

Optical Coherence Tomography (OCT) and other imaging systems (e.g., other forms of microscopy, optical projection tomography, ultrasound imaging, and photoacoustic imaging) have long been used to image objects and/or tissue in humans and animals to, for example, identify and diagnose disease. However, some of these systems have limited resolution and contrasting capabilities and high image distortion, which leads to poor image quality and limited clinical and medical efficacy. Accordingly, there is a need for reconstruction techniques that utilize the multi-dimensional data that is captured by these systems to provide improved resolution and contrasting capabilities without high image distortion.

### BRIEF SUMMARY

Systems and techniques for image reconstruction using computational image contrast from multi-dimensional data are described herein. Advantageously, the described systems and methods provide improved contrast and resolution without image distortion and are modality agnostic. Accordingly, any system that is capable of acquiring multi-dimensional data can utilize the techniques provided herein to improve contrast and resolution without image distortion.

A method of performing computational image contrast from multi-dimensional data includes receiving a plurality of images of an object, with each image of the plurality of images having more than three dimensions, performing multi-dimensional registration of the plurality of images to generate a multi-dimensional dataspace, reducing dimensionality of the multi-dimensional dataspace to create an enhanced resolution and contrast image of a 3D space of the object using the plurality of images as registered in the multi-dimensional dataspace, and displaying the enhanced resolution and contrast image.

In some cases, reducing the dimensionality of the multi-dimensional dataspace to create the enhanced resolution and contrast image of the 3D space of the object includes utilizing at least one of variance, high-order statistics, entropy, principal component analysis, t-distributed stochastic neighborhood embedding, and neural networks using the plurality of images as registered in the multi-dimensional dataspace. In some cases, the at least one of the variance, high-order statistics, entropy, principal component analysis, t-distributed stochastic neighborhood embedding, and neural networks are determined by applying an iterative optimization algorithm to the plurality of images as registered in the multi-dimensional dataspace. In some cases, the method further includes taking a Fourier transform of the plurality of registered images prior to reducing the dimensionality of the multi-dimensional dataspace. In some cases, the plurality of images of the object are one of optical coherence tomography B-scans and OCT volumes. In some cases, the multi-dimensional dataspace is at least a five-dimensional dataspace. In some cases, the at least five-dimensional dataspace includes space and angular dimensions. In some cases, the at least five-dimensional dataspace further includes time and wavelength dimensions. In some cases, reducing the dimensionality of the multi-dimensional dataspace to create the enhanced resolution and contrast image of the 3D space includes reducing the dimensionality of the multi-dimensional dataspace to create a plurality of enhanced resolution and contrast images of the 3D space of the object, wherein the plurality of enhanced resolution and contrast images of the 3D space of the object comprises the enhanced resolution and contrast image of the 3D space of the object.

A system to perform the method described above and one or more storage media including instructions to perform the method described above are also included. In some cases, the system further includes an imaging device that acquires the plurality of images of the object (with each image of the plurality of images having more than three dimensions) and sends the plurality of images of the object to the storage system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a flow diagram of a method of performing computational image contrast from multi-dimensional data as provided herein.

FIGS. 2A-2F illustrate 2D cross-sections of 3D Optical Coherence Tomography reconstructions computed based on the mean and standard deviation of OCT reflectivity across all dimensions.

FIG. 3A illustrates a system controller for implementing functionality of a multi-dimensional data acquiring system.

FIG. 3B illustrates a computing system that can be used for a computational image contrast system.

### DETAILED DESCRIPTION

Systems and techniques for image reconstruction using computational image contrast from multi-dimensional data are described herein. Advantageously, the described systems and methods provide improved contrast and resolution without image distortion and are modality agnostic. Accordingly, any system that is capable of acquiring multi-dimensional data can utilize the techniques provided herein to improve contrast and resolution without image distortion.

As used herein, multi-dimensional data refers to data that includes more than three dimensions and a multi-dimensional dataspace refers to a dataspace that includes the more than three dimensions. For example, multi-dimensional data may include the three spatial dimensions (i.e., 3D) and at least one other dimension (e.g., angular dimension). In some cases, multi-dimensional data includes 3D data along with two angular dimensions. The angular dimensions may be acquired, for example, by acquiring data from various angles around an object being imaged (e.g., by moving the object itself or by moving the imaging system around the object). In some cases, multi-dimensional data includes 3D data along with other dimensions such as angular, time, polarization, and/or wavelength dimensions.

As mentioned above, the described systems and methods providing improved contrast and resolution without image distortion are modality agnostic. Therefore, while some examples described herein may refer to OCT, these examples should not be considered limiting as the described systems and methods may be applied to other imaging modalities such as other forms of microscopy, optical projection tomography, and ultrasound imaging.

Previous work on improving contrast in images from OCT systems involved calculating the mean of the multi-dimensional data when reducing the dimensions for reconstructing an image. However, using only the mean of the multi-dimensional data forgoes many potential improvements to image contrast and resolution that could be realized by utilizing calculation(s) of variance, high-order statistics, entropy, principal component analysis, t-distributed stochastic neighborhood embedding, and neural networks of the multi-dimensional data.

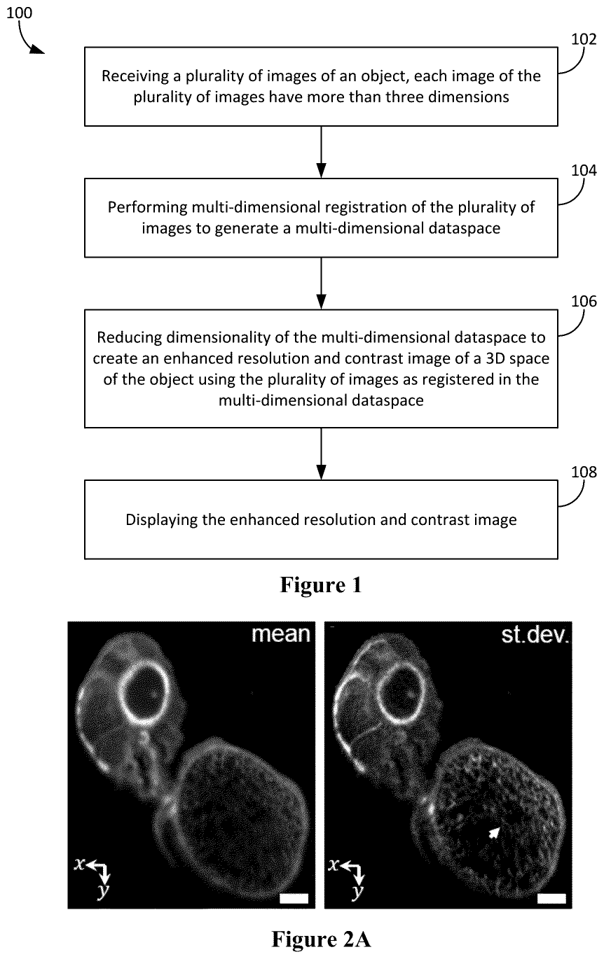

FIG. 1 illustrates a flow diagram of a method of performing computational image contrast from multi-dimensional data as provided herein. Referring to FIG. 1, a method 100 of performing computational image contrast from multidimensional data includes receiving (102) a plurality of images of an object, with each image of the plurality of images having more than three dimensions, performing (104) multi-dimensional registration of the plurality of images to generate a multi-dimensional dataspace, reducing (106) dimensionality of the multi-dimensional dataspace to create an enhanced resolution and contrast image of a 3D space of the object using the plurality of images as registered in the multi-dimensional dataspace, and displaying (108) the enhanced resolution and contrast image.

In some cases, reducing the dimensionality of the multi-dimensional dataspace to create the enhanced resolution and contrast image of the 3D space of the object includes utilizing at least one of variance, high-order statistics, entropy, principal component analysis, t-distributed stochastic neighborhood embedding, and neural networks using the plurality of images as registered in the multi-dimensional dataspace. Utilization of at least one of variance, high-order statistics, entropy, principal component analysis, t-distributed stochastic neighborhood embedding, and neural networks should not be considered an exhaustive list, as other forms of calculations can be used to create an enhanced resolution and contrast image using the methods and systems described herein. Furthermore, in some cases, more than one of the variance, high-order statistics, entropy, principal component analysis, t-distributed stochastic neighborhood embedding, and neural networks (and/or other forms of calculations not specifically recited herein) can be used in conjunction to create the enhanced resolution and contrast image.

For example, data collection for 3D optical coherence refraction tomography (OCRT) yields a 5D datacube that includes OCT backscattered signals as a function of 3D space and 2D orientation. This 5D datacube may be expressed as OCT (x, y, z, kₓ, k_{y}). After performing (104) multi-dimensional registration, the 5D datacube (e.g., representing an object) can be inserted, as part of the reducing (106) step, into the following equation:

$${OCRT}_{F} ( x , y , z ) = {F}_{( x , y , z , {k}_{x} , {k}_{y} ) \to ( x , y , z )} \{ OCT ( x , y , z , {k}_{x} , {k}_{y} ) \} , \qquad ( 1 )$$

where F is an operator that eliminates (e.g., angular) dimensions, kₓ and k_{y}. F performs the variance, high-order statistics, entropy, principal component analysis, t-distributed stochastic neighborhood embedding, and neural networks calculations. These variance, high-order statistics, entropy, principal component analysis, t-distributed stochastic neighborhood embedding, and neural networks calculations yield significant information about the shape of angular backscatter distribution. An argmax function can identify the incidence angle that gives the highest backscatter signal, which would thus produce a 3D orientation map of the sample.

In some cases, taking a Fourier transform across dimensions (e.g., angular dimensions) before reduction (106) yields structural information about the object. In some cases, to identify spatial locations that exhibit a specific angular backscatter distribution profile, template-matching via cross-correlation or mean square error can be utilized. Data-driven linear or nonlinear dimensionality-reduction strategies, such as principle component analysis (PCA), t-distributed stochastic neighborhood embedding (t-SNE), or neural networks can be leveraged to collapse the dimensions (e.g., angular dimensions).

In some cases, in addition to kₓ and k_{y}, F can also operate along space, time, and wavenumber (x, y, z, t, k) through the following equation:

$${OCRT}_{F} ( x , y , z ) = {F}_{( x , y , z , t , {k}_{x} , {k}_{y} , k ) \to ( x , y , z )} \{ OCT ( x , y , z , t , {k}_{x} , {k}_{y} , k ) \} , \qquad ( 2 )$$

Therefore, F can also include spatial convolutions and temporal fluctuation-based approaches, such as OCT angiography (OCTA) and dynamic OCT. It should be noted that this equation can be considered as a generalization of split-spectrum amplitude-decorrelation (SSADA), which is an OCTA algorithm that splits the OCT spectrum into multiple bands and averages their decorrelation results for improved signal-to-noise ratio (SNR). In other words, while SSADA uses multiple OCT source spectral bands, this approach additionally uses multiple angular ranges to yield not only SNR gains from averaging, but also additional information through other operations that operate across space time, angle, and/or wavelength. For example, to achieve high spectral resolution, one could implement OCRT with multiple independent scanning beams.

As an example of mapping a 5D datacube to 3D OCRT reconstruction, consider a case where F in Equation (1) computes the angular variance in the following equation:

$${OCRT}_{VAR} ( x , y , z ) ∝ \int {\int }_{{k}_{x} , {k}_{y}} {( OCT ( x , y , z , {k}_{x} , {k}_{y} ) - {OCRT}_{mean} ( x , y , z ) )}^{2} {dk}_{x} {dk}_{y} , = \int {\int }_{{k}_{x} , {k}_{y}} {OCT}^{2} ( x , y , z , {k}_{x} , {k}_{y} ) {dk}_{x} {dk}_{y} - {OCRT}_{mean}^{2} ( x , y , z ) \qquad ( 3 )$$

where, in practice, the right side of the equal sign only requires two mappings from the OCT datacube space to the OCRT reconstruction space (i.e., OCT→OCRTₘₑₐₙ and OCT²→OCRT²), thus allowing direct application of the moving based reconstruction algorithm. The left side of the equal sign would have required performance of an extra inverse mapping step from OCRT space to OCT space (in addition to two forward mappings). A variance-based OCRT reconstruction would highlight anisotropically backscattering structures, such as an oriented flat surface. For example, an ideal spherical particle would yield no variance signal, as the backscattered signal would be independent of incidence angles. An example of orientation-sensitive structures are Henle's fiber layer of the retina, whose reconstructed OCRT signal can be attenuated when angular averaging is utilized (i.e., as represented by the equation: OCRTₘₑₐₙ (x, y, z) ∞∫∫ₖ_{ₓ}ₖ_{_{y}}OCT(x, y, z, kₓ, k_{y})dkₓdk_{y}.

Although the examples above are described in the context of multi-dimensional OCT data, the same strategies and algorithms can be applied to other imaging modalities, including, but not limited to, other forms of microscopy, optical projection tomography, and ultrasound imaging.

In some cases, at least one of the variance, high-order statistics, entropy, principal component analysis, t-distributed stochastic neighborhood embedding, and neural networks are determined (e.g., in the reducing (106) step) by applying an iterative optimization algorithm to the plurality of images as registered in the multi-dimensional dataspace. In some cases, high-order statistics refer to functions that utilize the third or higher power of a sample (e.g., skewness and kurtosis). In some cases, entropy refers to the number of ways a system can be arranged and/or the degree of disorder or uncertainty in a system. As applied to the object being imaged in the context of this invention, entropy can refer to the number of ways in which the data associated with the plurality of images can be arranged (e.g., which can be used to find the best solution of how the object actually appears).

In some cases, the method further includes taking a Fourier transform of the plurality of registered images prior to reducing (106) the dimensionality of the multi-dimensional dataspace. In some cases, the plurality of images of the object are one of optical coherence tomography B-scans and OCT volumes. In some cases, the multi-dimensional dataspace is at least a five-dimensional dataspace (e.g., a 5D datacube). In some cases, the at least five-dimensional dataspace includes space and angular dimensions (e.g., as described with respect to Equation (1)). In some cases, the at least five-dimensional dataspace further includes time and wavelength dimensions (e.g., as described with respect to Equation (2)). In some cases, reducing (106) the dimensionality of the multi-dimensional dataspace to create the enhanced resolution and contrast image of the 3D space further includes utilizing at least one of principal component analysis, t-distributed stochastic neighborhood embedding, and neural networks.

In some cases, reducing (106) the dimensionality of the multi-dimensional dataspace to create the enhanced resolution and contrast image of the 3D space of the object includes reducing the dimensionality of the multi-dimensional dataspace to create a plurality of enhanced resolution and contrast images of the 3D space of the object.

As a specific example, if RGB dimensions are included in the multi-dimensional data, reducing (106) the dimensionality of the multi-dimensional dataspace to create a plurality of enhanced resolution and contrast images of the 3D space of the object can include creation of an enhanced resolution and contrast image that includes red spectral light, an enhanced resolution and contrast image that includes green spectral light, and an enhanced resolution and contrast image that includes green spectral light.

In another specific example, reducing (106) the dimensionality of the multi-dimensional dataspace to create a plurality of enhanced resolution and contrast images of the 3D space of the object can include utilizing three different dimensionality techniques (e.g., one of variance, high-order statistics, entropy, principal component analysis, t-distributed stochastic neighborhood embedding, and neural networks) to create a 3-channel, enhanced resolution and contrast image. It should be understood that while three channels are mentioned in this example, any number of channels may be used to create the enhanced resolution and contrast image.

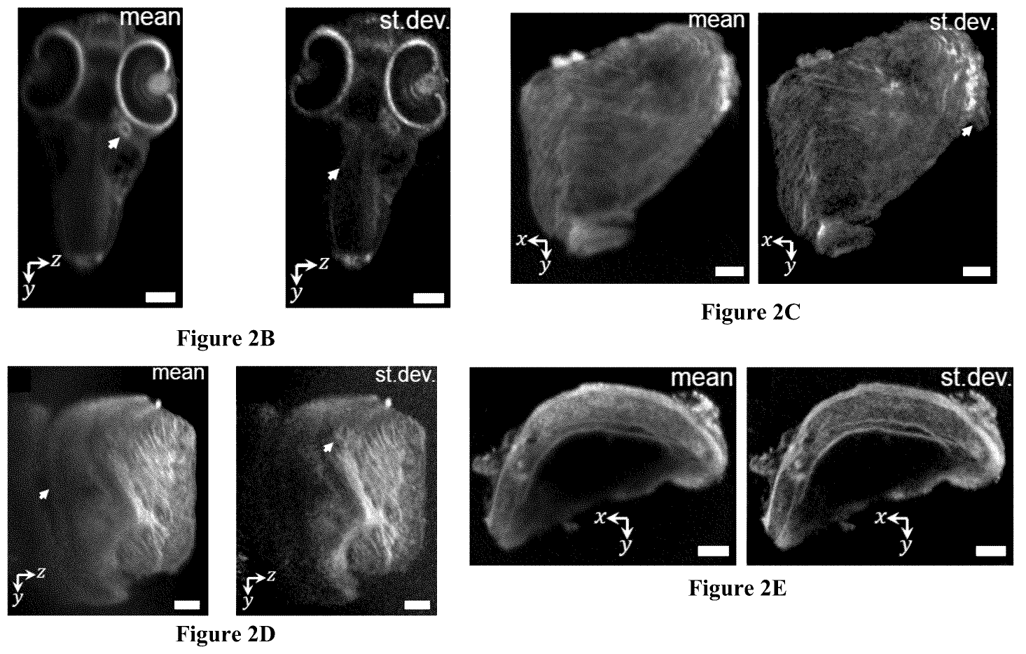

FIGS. 2A-2F illustrate 2D cross-sections of 3D Optical Coherence Tomography reconstructions computed based on the mean and standard deviation of OCT reflectivity across all dimensions. Referring to FIGS. 2A-2F, the left image in each Figure represents a 2D cross-section of 3D Optical Coherence Tomography reconstructions of zebrafish and mouse samples computed based on the mean of OCT reflectivity across all dimensions (e.g., including angles); and the right image in each Figure represents a 2D cross-section of 3D Optical Coherence Tomography reconstructions of zebrafish and mouse samples computed based on the standard deviation of OCT reflectivity across all dimensions (e.g., including angles). As can be seen in each Figure, the right image (representing the standard deviation of OCT reflectivity across all dimensions) illustrates improved contrast and resolution without image distortion as compared to the left image (representing the mean of OCT reflectivity across all dimensions).

The described method can be performed by any suitable system having a processor and one or more storage media including instructions to perform the method 100. In some cases, such systems further include an imaging device (e.g., a microscopy, optical projection tomography, and/or ultrasound imaging device) that acquires the plurality of images of the object (with each image of the plurality of images having more than three dimensions) and a storage system (which may be part of or separate from the one or more storage media) that stores the plurality of images of the object.

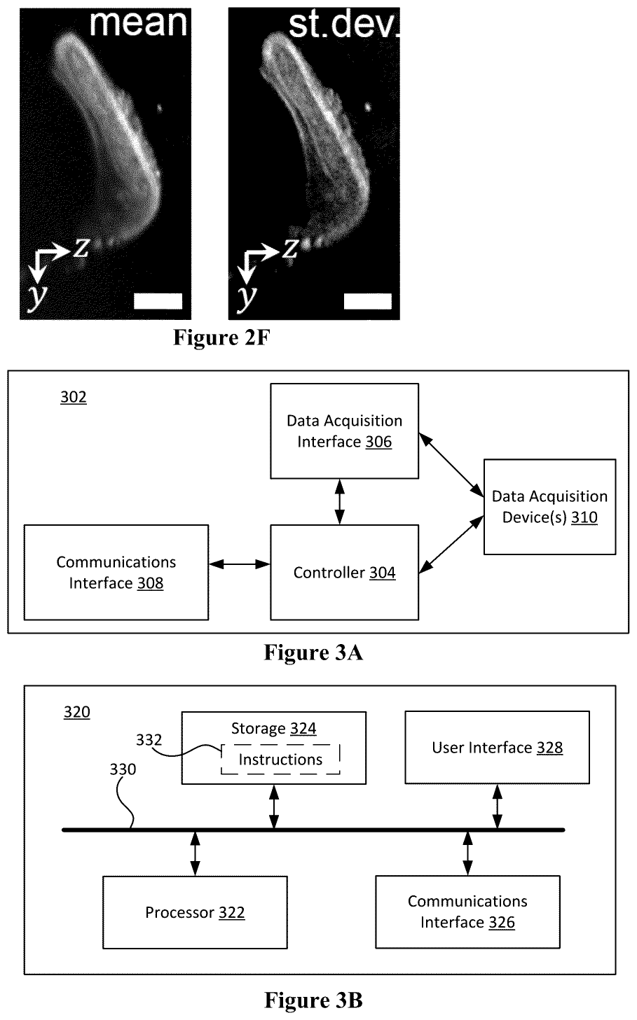

FIG. 3A illustrates components of a multi-dimensional data acquiring system (e.g., a microscopy, optical projection tomography, or ultrasound imaging). Referring to FIG. 3A, a multi-dimensional data acquiring system 302 can include a controller 304 coupled to one or more data acquisition devices 310 (e.g., camera sensor(s), transducer(s) and/or receiver(s), etc.) that are used to capture/acquire a plurality of images of an object. The controller 304 can receive data from the one or more data acquisition devices 310 via a data acquisition interface 306. In some cases, the controller 304 can be used to control operation (and optionally movement of) the one or more data acquisition devices 310. In some cases, the controller 304 can include or be coupled to a communications interface 308 for communicating with another computing system, for example computing system 320 of FIG. 3B. Controller 304 can include one or more processors with corresponding instructions for execution and/or control logic for controlling the multi-dimensional data acquiring system 302 to acquire a plurality of images of an object and can include instructions (executed by the one or more processors) and/or control logic. Images captured by the one or more data acquisition devices can be processed at the controller 304 or communicated/sent to another computing device via the communications interface 308.

FIG. 3B illustrates a computing system that can be used for a computational image contrast system. Referring to FIG. 3B, a computing system 320 can include a processor 322, storage 324, a communications interface 326, and a user interface 328 coupled, for example, via a system bus 330. Processor 322 can include one or more of any suitable processing devices (“processors”), such as a microprocessor, central processing unit (CPU), graphics processing unit (GPU), field programmable gate arrays (FPGAs), application-specific integrated circuits (ASICs), logic circuits, state machines, application-specific standard products (ASSPs), system-on-a-chip systems (SOCs), complex programmable logic devices (CPLDs), etc. Storage 324 can include any suitable storage media that can store instructions 332 for performing computational image contrast from multi-dimensional data, such as for example, method 100. Suitable storage media for storage 324 includes random access memory, read only memory, magnetic disks, optical disks, CDs, DVDs, flash memory, magnetic cassettes, magnetic tape, magnetic disk storage or other magnetic storage devices, or any other suitable storage media. As used herein “storage media” do not consist of transitory, propagating waves. Instead, “storage media” refers to non-transitory media.

Communications interface 326 can include wired or wireless interfaces for communicating with other systems, including system 302 such as described with respect to FIG. 3A as well as for communicating with the “outside world” (e.g., external networks). User interface 328 can include output interfaces including for a display on which the enhanced resolution and contrast images can be displayed as well as suitable input device interfaces for receiving user input (e.g., mouse, keyboard, microphone). In some cases, a display can be part of system 320.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
receiving a plurality of images of an object, each image of the plurality of images having more than three dimensions;
performing multi-dimensional registration of the plurality of images to generate a multi-dimensional dataspace;
reducing dimensionality of the multi-dimensional dataspace to create an enhanced resolution and contrast image of a 3D space of the object using the plurality of images as registered in the multi-dimensional dataspace; and
displaying the enhanced resolution and contrast image.

2. The method of claim 1, wherein reducing the dimensionality of the multi-dimensional dataspace to create the enhanced resolution and contrast image of the 3D space of the object comprises utilizing at least one of variance, high-order statistics, entropy, principal component analysis, t-distributed stochastic neighborhood embedding, and neural networks using the plurality of images as registered in the multi-dimensional dataspace.

3. The method of claim 2, wherein the at least one of the variance, high-order statistics, entropy, principal component analysis, t-distributed stochastic neighborhood embedding, and neural networks are determined by applying an iterative optimization algorithm to the plurality of images as registered in the multi-dimensional dataspace.

4. The method of claim 1, further comprising taking a Fourier transform of the plurality of registered images prior to reducing the dimensionality of the multi-dimensional dataspace.

5. The method of claim 1, wherein the plurality of images of the object are one of optical coherence tomography B-scans and OCT volumes.

6. The method of claim 1, wherein the multi-dimensional dataspace is at least a five-dimensional dataspace.

7. The method of claim 6, wherein the at least five-dimensional dataspace comprises space and angular dimensions.

8. The method of claim 7, wherein the at least five-dimensional dataspace further comprises time and wavelength dimensions.

9. The method of claim 1, wherein reducing the dimensionality of the multi-dimensional dataspace to create the enhanced resolution and contrast image of the 3D space of the object comprises reducing the dimensionality of the multi-dimensional dataspace to create a plurality of enhanced resolution and contrast images of the 3D space of the object, wherein the plurality of enhanced resolution and contrast images of the 3D space of the object comprises the enhanced resolution and contrast image of the 3D space of the object.

10. A system comprising:
a processing system;
a storage system; and
instructions stored on the storage system that when executed by the processing system direct the processing system to at least:
receive a plurality of images of an object, each image of the plurality of images having more than three dimensions;
perform multi-dimensional registration of the plurality of images to generate a multi-dimensional dataspace;
reduce dimensionality of the multi-dimensional dataspace to create an enhanced resolution and contrast image of a 3D space of the object using the plurality of images as registered in the multi-dimensional dataspace; and
display the enhanced resolution and contrast image.

11. The system of claim 10, wherein the instructions that direct the processing system to reduce the dimensionality of the multi-dimensional dataspace to create the enhanced resolution and contrast image of the 3D space of the object comprise instructions to utilize at least one of variance, high-order statistics, entropy, principal component analysis, t-distributed stochastic neighborhood embedding, and neural networks using the plurality of images as registered in the multi-dimensional dataspace.

12. The system of claim 11, wherein the at least one of the variance, high-order statistics, entropy, principal component analysis, t-distributed stochastic neighborhood embedding, and neural networks are determined by applying an iterative optimization algorithm to the plurality of images as registered in the multi-dimensional dataspace.

13. The system of claim 10, further comprising:
an imaging device, wherein the imaging device acquires the plurality of images of the object taken at different angles and sends the plurality of images of the object taken at different angles to the storage system.

14. The system of claim 10, wherein the instructions executed by the processing system further direct the processing system to at least take a Fourier transform of the plurality of registered images prior to reducing the dimensionality of the multi-dimensional dataspace.

15. The system of claim 10, wherein the plurality of images of the object are one of optical coherence tomography B-scans and OCT volumes.

16. The system of claim 10, wherein the multi-dimensional dataspace is at least a five-dimensional dataspace.

17. The system of claim 16, wherein the at least five-dimensional dataspace comprises space and angular dimensions.

18. The system of claim 17, wherein the at least five-dimensional dataspace further comprises time and wavelength dimensions.

19. The system of claim 10, wherein the instructions that direct the processing system to reduce the dimensionality of the multi-dimensional dataspace to create the enhanced resolution and contrast image of the 3D space of the object comprise instructions to reduce the dimensionality of the multi-dimensional dataspace to create a plurality of enhanced resolution and contrast images of the 3D space of the object,
wherein the plurality of enhanced resolution and contrast images of the 3D space of the object comprises the enhanced resolution and contrast image of the 3D space of the object.

20. One or more storage media having instructions stored thereon that when executed by a processing system direct the processing system to at least:
receive a plurality of images of an object, each image of the plurality of images having more than three dimensions taken at different angles;
perform multi-dimensional registration of the plurality of images to generate a multi-dimensional dataspace;
reduce dimensionality of the multi-dimensional dataspace to create an enhanced resolution and contrast image of a 3D space of the object using the plurality of images as registered in the multi-dimensional dataspace; and
display the enhanced resolution and contrast image.
